(19) United States
(12) Patent Application Publication
(10) Pub. No.: US 2009/0230703 A1
(43) Pub. Date: Sep. 17, 2009

(54) LATCH MECHANISM

(76) Inventors: Peter J. Coleman, Worcestershire (GB); Nigel Victor Spurr, Solihull (GB)

Correspondence Address: CARLSON, GASKEY & OLDS, P.C., 400 WEST MAPLE ROAD, SUITE 350, BIRMINGHAM, MI, 48009, US

(21) Appl. No.: 12/389,482

(22) Filed: Feb. 20, 2009

(30) Foreign Application Priority Data
Mar. 17, 2008 (GB) 0804973.6

(51) Int. Cl. E05C 3/06; E05C 3/16

(52) U.S. Cl. 292/201; 292/216

(57) ABSTRACT

A latch mechanism includes a latch chassis, a latch bolt having a closed position and an open position, a pawl having an engaged position at which the pawl holds the latch bolt in the closed position and a disengaged position at which the pawl allows the latch bolt to move to the open position, and a first release handle operably connected to the pawl via a transmission path to selectively move the pawl from the engaged position to the disengaged position. The transmission path includes a toggle linkage having a first link pivotable about a first axis and a second link pivotable about a second axis, the first link and the second link being pivotable relative to each other about a common axis. The latch mechanism includes a stop to limit rotation of the second link in a first direction relative to the first link. The toggle linkage has a first toggle linkage position where the common axis is positioned on a first side of a line joining the first axis and the second axis, and the stop is engaged to operably couple the first release handle with the pawl. The toggle linkage has a second toggle linkage position where the common axis is positioned on a second side of the line joining the first axis and the second axis to operably decouple the first release handle from the pawl.

### REFERENCE TO RELATED APPLICATION

This application claims priority to United Kingdom Patent Application No. 0804973.6 filed Mar. 17, 2008.

### BACKGROUND OF THE INVENTION

The present invention relates generally to latch mechanisms, in particular to latch mechanisms which are lockable.

Lockable latch mechanisms are known in which, in an unlocked condition, operation of a handle causes a pawl to disengage from a latch bolt, thereby releasing the latch. When in a locked condition, the handle is operably disconnected from the pawl so that the handle “free wheels” when operated, i.e., operation of the handle does not disengage the pawl from the latch bolt.

Two such arrangements are shown in GB2342383 and U.S. Pat. No. 6,286,878. In these cases, the transmission paths between the handles and the pawls includes a gap. In the unlocked position, a wedge fills the gap, and in the locked position, the wedge is removed from the gap. When the door handle is actuated when the mechanism is in its locked position, if the mechanism is unlocked while the handle is still actuated, then a motor drives the wedge between the gap, thereby releasing the latch. The arrangement allows the handle to be pulled once the system is in the locked position, and by continuing to hold the handle, the door can be opened. It is not necessary to pull the handle, release the handle, and then pull the handle for a second time to open the latch.

However, the problem with this invention is that the power required to drive the wedge between the gap is significant, and hence a relatively powerful motor is required. Relatively powerful motors are expensive, bulky, heavy and require relatively large amounts of energy to operate.

### SUMMARY OF THE INVENTION

The present invention provides an improved latch mechanism. The latch mechanism includes a latch chassis, a latch bolt having a closed position and an open position, a pawl having an engaged position at which the pawl holds the latch bolt in the closed position and a disengaged position at which the pawl allows the latch bolt to move to the open position, and a first release handle operably connected to the pawl via a transmission path to selectively move the pawl from the engaged position to the disengaged position. The transmission path includes a toggle linkage having a first link pivotable about a first axis and a second link pivotable about a second axis. The first link and the second link are pivotable relative to each other about a common axis. The latch mechanism includes a stop to limit rotation of the second link in a first direction relative to the first link. The toggle linkage has a first toggle linkage position where the common axis is positioned on a first side of a line joining the first axis and the second axis, and the stop is engaged to operably couple the first release handle with the pawl. The toggle linkage has a second toggle linkage position where the common axis is positioned on a second side of the line joining the first axis and the second axis to operably decouple the first release handle from the pawl.

### BRIEF DESCRIPTION OF DRAWINGS

The invention will now be described, by way of example only, with reference to the accompanying drawings in which:

FIG. 1 shows part of a latch mechanism in an unlocked rest position;

FIG. 2 shows the latch mechanism of FIG. 1 in a locked rest position;

FIG. 3 shows the latch mechanism of FIG. 1 in a locked position with an inside door handle in an actuated position;

FIG. 4 shows the latch mechanism of FIG. 1 in a release position with the inside handle in the actuated position;

FIG. 5 shows the latch mechanism of FIG. 1 in a locked position with an outside door handle in an actuated position; and

FIG. 6 shows the latch mechanism of FIG. 1 in a release position with the outside handle in the actuated position.

### DETAILED DESCRIPTION OF THE PREFERRED EMBODIMENT

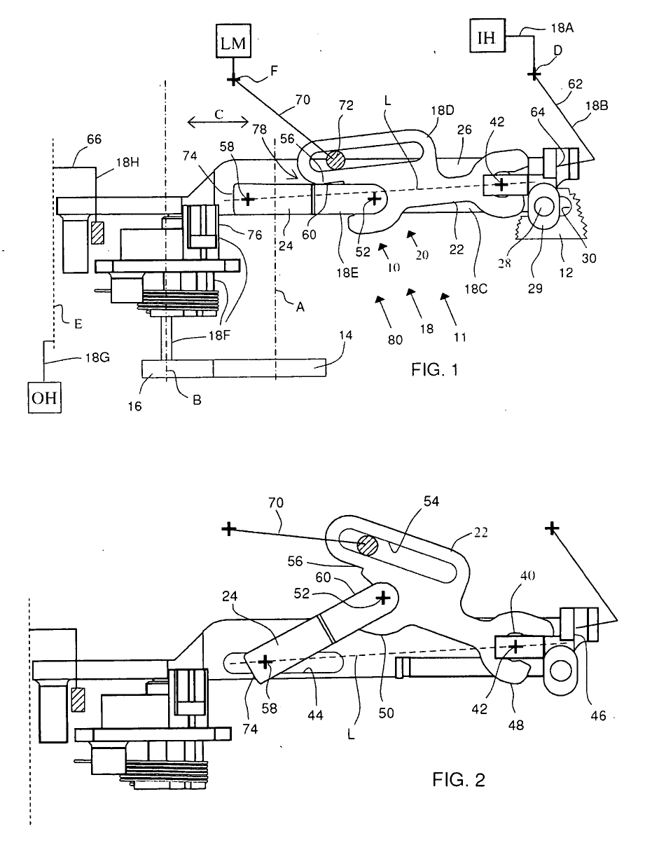

The figures show a latch mechanism 10 including a latch 11 having a latch chassis 12 (only part of which is shown). The latch 11 includes a latch bolt 14 (shown schematically in FIG. 1) rotatable about an axis A between a closed position and an open position. A pawl 16 is rotatable about a pawl axis B between an engaged position, at which the pawl 16 holds the latch bolt 14 in a closed position, and a disengaged position, at which the pawl 16 allows the latch bolt 14 to move to the open position.

The latch 11 will typically be provided on a rear edge of a door, such as a vehicle door, for example a car. The latch mechanism 10 includes an inside handle IH (shown schematically in FIG. 1) and an outside handle OH (shown schematically in FIG. 1). A transmission path 18 selectively couples the inside handle IH and the outside handle OH to the pawl 16. A toggle linkage 20 includes a first link 22 and a second link 24.

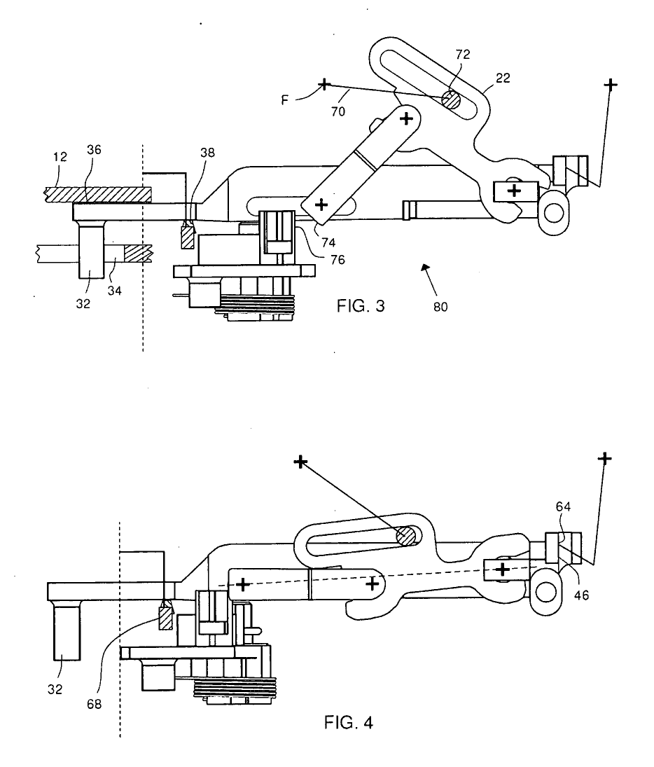

The latch mechanism 10 also includes a linkage carrier 26. The linkage carrier 26 is generally elongate and is guided to move laterally (when viewing the Figures) from the position shown in FIGS. 1 and 2 to the position shown in FIGS. 3 to 6. There is a pin 28 at the right hand end (when viewing FIG. 1) of the linkage carrier 26 which projects into the paper when viewing FIG. 1. The pin 28 is guided in a slot 30 of the latch chassis 12. An edge of the slot 30 is sandwiched between an oval end 29 of the pin 28 and the region of the right hand end of the linkage carrier 26 obscured by the oval end 29.

There is a pin 32 at the left hand end (when viewing FIG. 1) of the linkage carrier 26 which is guided in a slot 34 of the latch chassis 12. A chassis abutment 36 is provided above the left hand end (when viewing FIG. 3) of the linkage carrier 26 to prevent the left hand end of the linkage carrier 26 moving upwardly during operation. An abutment 38 of the transmission path 18 is provided to ensure that the left hand end of the linkage carrier 26 does not move downwardly during operation. As such, the linkage carrier 26 is constrained to move laterally in the direction of an arrow C during operation.

The linkage carrier 26 includes a pin 40 towards its right hand end when viewing FIG. 2, which defines a first axis 42 of the first link 22. The linkage carrier 26 also includes an elongate slot 44 and an abutment 46.

The first link 22 has an arcuate end 48 which snap fits around the pin 40. As such, the first link 22 is pivotable about the first axis 42. The first link 22 also includes an arcuate portion 50 which snap fits around a pin (not shown, but which defines a common axis 52) of the second link 24. The first link 22 and the second link 24 are therefore pivotable relative to each other about the common axis 52. The first link 22 also includes an elongate slot 54 and an abutment portion 56. The second link 24 is generally elongate and includes a pin (not shown, but which defines a second axis 58) which sits in the slot 44. The second link 24 includes an abutment portion 60.

A lever 62 (shown schematically) is pivotable about an axis D and includes an abutment 64 which is selectively engageable with the abutment 46 of the linkage carrier 26. A lever 66 (shown schematically) is pivotable about an axis E and includes an abutment 68. A lever 70 (shown schematically) is pivotable about a lever axis F and includes a pin 72 which sits in the elongate slot 54 of the first link 22. A lock motor LM is operably coupled to the lever 70. The second link 24 includes an abutment 74 which is selectively engageable with an abutment 76 of the transmission path 18.

The transmission path 18 includes several transmission path portions: 18A which couples the inside handle IH to the lever 62, 18B which includes the lever 62, 18C which includes the linkage carrier 26, 18D which includes the first link 22, 18E which includes the second link 24, 18F which couples the abutment 74 of the second link 24 with the pawl 16, 18G which couples the outside handle OH to the lever 66, and 18H which includes the lever 66.

Operation of the latch mechanism is as follows. In summary, the first link 22 and the second link 24 can either act as a strut in compression to transmit a load from the pin 40 to the abutment 76, or the strut formed by the first link 22 and the second link 24 can “buckle,” as shown in FIG. 2. Under these circumstances, a load applied at the pin 40 is not transmitted to the abutment 76 (see FIG. 3). However, when the “buckled strut” formed by the first link 22 and the second link 24 is straightened by the lock motor LM, it moves to the position shown in FIG. 4, thereby transferring the force from the pin 40 to the abutment 76.

In more detail, as shown in FIG. 1, the common axis 52 is positioned to one side (in this case below) of a line L drawn between the first axis 42 and the second axis 58. In these circumstances, the abutment portion 56 of the first link 22 is engaged with the abutment portion 60 of the second link 24, thereby forming a stop 78. The stop 78 prevents the second link 24 rotating further clockwise about the common axis 52 relative to the first link 22. As such, the first link 22 and the second link 24, together with the appropriately positioned stop 78, form a stable strut 80. When the inside door handle IH is actuated, the movement of the inside door handle IH is transmitted via the transmission path portion 18A to the lever 62, which is caused to rotate clockwise (when viewing FIG. 1) about the axis D, thereby causing the abutment 64 of the lever 62 to drive the linkage carrier 26 to the left when viewing FIG. 1. This causes the pin 40 to move to the left, and hence the strut 80 to move to the left, which results in the abutment 74 of the second link 24 engaging the abutment 76 and causing the transmission path portion 18F to rotate about the pawl axis B, thereby moving the pawl 16 from its engaged position to its disengaged position, and hence allowing the latch bolt 14 to release the latch 11. Operation of the inside handle IH with the latch mechanism 10 unlocked therefore moves the components from the FIG. 1 position to the FIG. 4 position.

With regard to the outside handle OH, starting at the FIG. 1 position, operation of the outside handle OH causes the transmission path portion 18G to rotate the lever 66 about the axis E, which causes the abutment 68 to engage and move the pin 32 of the linkage carrier 26 to the left when viewing FIG. 1. This causes the latch 11 to be released as the strut 80 engages the abutment 76 and rotates the transmission path portion 18F about the pawl axis B to rotate the pawl 16 to disengage from the latch bolt 14. Thus, when the outside handle OH is operated with an unlocked latch, the components move from the FIG. 1 position to the FIG. 6 position.

Note that in the FIG. 6 position, the abutment 68 is engaged with the pin 32, but the abutment 64 is spaced from the abutment 46. This can be contrasted with FIG. 4, where the abutment 68 is spaced from the pin 32, and the abutment 64 is in engagement with the abutment 46.

Note that in FIGS. 1, 4 and 6, the lever 70, and in particular the pin 72, is in the same position. Because in FIGS. 4 and 6 the first link 22 has moved leftwardly when compared with FIG. 1, the pin 72 is closer to the right hand end (when viewing FIGS. 4 and 6) of the elongate slot 54 when compared with FIG. 1.

FIG. 2 shows the latch mechanism 10 in a locked position. In this case, the lever 70 has been caused to rotate counter-clockwise (by operation of the lock motor LM) about the lever axis F, thereby generally raising the pin 72, which in turn causes the first link 22 to rotate clockwise about the first axis 42 to the FIG. 2 position. This has caused the second link 24 to rotate about the second axis 58. The left hand end of the second link 24 has also been caused to translate along the slot 44 i.e., the second axis 58 has been caused to translate along the slot 44. Significantly, the common axis 52 lies on an opposite side (in this case above) of the line L drawn between the first axis 42 and the second axis 58. As shown in FIG. 2, the strut 80 has “buckled.” When either the inside handle IH or the outside handle OH is actuated, the linkage carrier 26 will move to the left, and once the abutment 74 has engaged the abutment 76 continued movement of the linkage carrier 26 to the left will simply cause the strut 80 to buckle further (as shown in FIG. 3). As such, the latch 11 will not release. It is the initial buckling of the strut 80 as shown in FIG. 2 and continued buckling of the strut 80 as shown in FIG. 3 that ensures the door is locked and will not open upon actuation of either the inside handle IH or the outside handle OH. Releasing either the inside handle IH or the outside handle OH will return the latch mechanism 10 from the FIG. 3 position to the FIG. 2 position.

In order to unlock the latch 11, the lock motor LM is actuated to cause the lever 70 and the pin 72 to rotate in a clockwise direction about the lever axis F, thereby moving the components from the FIG. 2 position to the FIG. 1 position.

However, it is also possible for the components, starting at the FIG. 2 position, to be moved to the FIG. 3 position by actuation of the inside handle IH, and then be moved to the FIG. 4 position (while the inside handle IH is still actuated) by actuation of the lock motor LM.

Thus, starting at the FIG. 2 position, actuation of the inside handle IH will move the components to the FIG. 3 position as described above. While the inside handle IH continues to be actuated, the lock motor LM can be operated to cause the lever 70 to rotate clockwise about the lever axis F. Because the pin 40 is being held in the FIG. 3 position by the actuated inside handle IH, then as the lever 70 is rotated in a clockwise direction, the pin 72 drives the first link 22 in a counter-clockwise rotational direction about the first axis 42. This causes the strut 80 to straighten out, resulting in the abutment 74 engaging and pushing on the abutment 76 to cause the pawl 16 to rotate. Note that throughout the process of moving the components from the FIG. 2 position through the FIG. 3 position to the FIG. 4 position, the inside handle IH has not been released (i.e., it has not been returned to its rest position). Once the FIG. 4 position has been achieved, then the inside handle IH can be released.

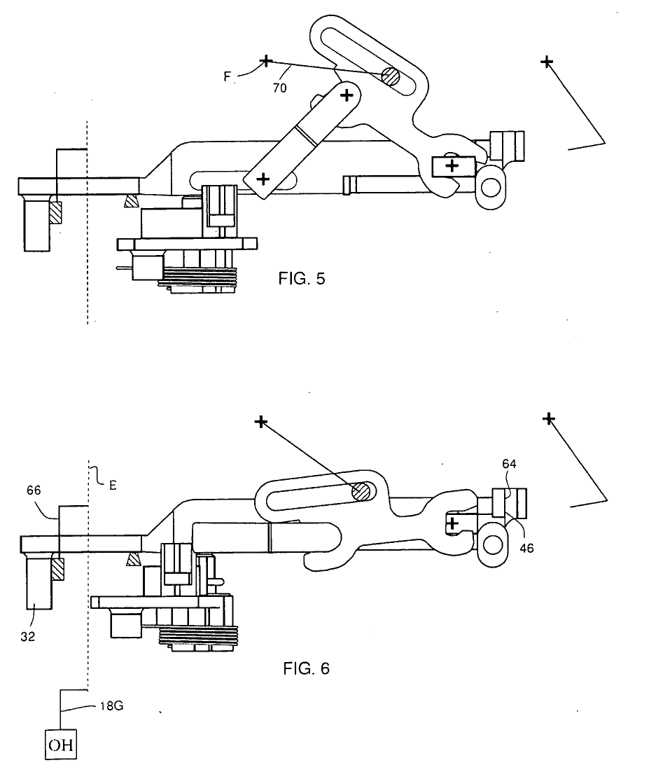

A similar mode of operation can be achieved by operating the outside handle OH. Thus, starting at the FIG. 2 position, the outside handle OH can be actuated, thereby moving the components to the FIG. 5 position. Whilst the outside handle OH continues to be actuated, the lock motor LM can be actuated, driving the lever 70 in a clockwise direction about the lever axis F, thereby moving the components to the FIG. 6 position. Once the FIG. 6 position is achieved the outside handle OH can be released.

As mentioned above, the line L shown in FIGS. 1 and 2 passes through the first axis 42 and the second axis 58. In both cases, the line L also passes through that part of the abutment 74 of the second link 24 that engages the abutment 76. The point on the abutment 74 which is engaged by the abutment 76 is the point at which a resistive load (i.e., a load application point) is applied to the second link 24 during opening of the latch 11. Thus, as shown in FIG. 1, the common axis 52 is positioned on one side (the lower side) of a line joining the first axis 42 to the load application point on the abutment 74. On FIG. 2, the common axis 52 is positioned on another side (i.e., above) the line joining the first axis 42 with the load application point on the abutment 74.

In further embodiments, the line L joining the first axis 42 and the second axis 58 need not be coincident with the line joining the first axis 42 and the load application point.

As mentioned above, the stop 78 is provided by the engagement between the abutment portion 56 of the first link 22 and the abutment portion 60 of the second link 24. In further embodiments, the stop 78 could be provided by a portion of the first link 22 engaging a stop portion on the latch chassis 12. Alternatively, the stop 78 could be provided by a portion of the second link 24 engaging a stop on the latch chassis 12.

The last part of the transmission path portion, i.e., the transmission path portion 18F, is relatively simple in as much as rotation of the abutment 76 directly rotates the pawl 16. In further embodiments, the transmission path portion that couples the abutment 74 of the second link 24 with the pawl 16 could be more complicated. Thus, the present invention is applicable to latches as shown in WO2006087578. For example, the toggle linkage 20 of the present invention could act to move the release plate 70 of WO2006087578 out of disengagement with the release abutment 65 of the release lever 52, thereby releasing the latch 10.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A latch mechanism comprising:
a latch chassis;
a latch bolt having a closed position and an open position;
a pawl having an engaged position at which the pawl holds the latch bolt in the closed position and a disengaged position at which the pawl allows the latch bolt to move to the open position;
a first release handle operably connected to the pawl via a transmission path to selectively move the pawl from the engaged position to the disengaged position;
the transmission path including a toggle linkage having a first link pivotable about a first axis and a second link pivotable about a second axis, the first link and the second link being pivotable relative to each other about a common axis; and
a stop to limit rotation of the second link in a first direction relative to the first link,
wherein the toggle linkage has a first toggle linkage position wherein the common axis is positioned on a first side of a line joining the first axis and the second axis, and the stop is engaged to operably couple the first release handle with the pawl, and
wherein the toggle linkage has a second toggle linkage position wherein the common axis is positioned on a second side of the line joining the first axis and second axis to operably decouple the first release handle from the pawl.

2. The latch mechanism as defined in claim 1 wherein the first release handle has a first handle rest position and a first handle actuated position, and with the first release handle in the first handle actuated position, the toggle linkage in the second toggle linkage position, and the pawl in the engaged position, movement of the toggle linkage to the first toggle linkage position operably couples the first release handle to the pawl to move the pawl to the disengaged position.

3. The latch mechanism as defined in claim 1 wherein the stop is provided by a part of the first link engaging a part of the second link.

4. The latch mechanism as defined in claim 1 wherein the stop is provided by a part of the first link engaging a part of the latch chassis or by a part of the second link engaging a part of the latch chassis.

5. The latch mechanism as defined in claim 1 wherein the first link is pivotally attached at the first axis to a linkage carrier, the linkage carrier having a carrier rest position corresponding to a first handle rest position, and the linkage carrier is moveable to a carrier actuated position by the first release handle when a first release handle is moved to a first handle actuated position.

6. The latch mechanism as defined in claim 1 wherein a guide arrangement is provided to guide the second axis along a predetermined path during operation of the latch mechanism.

7. The latch mechanism as defined in claim 6 wherein the first link is pivotally attached at the first axis to a linkage carrier, the linkage carrier having a carrier rest position corresponding to a first handle rest position, the linkage carrier is moveable to a carrier actuated position by the first release handle when the first release handle is moved to a first handle actuated position, and the guide arrangement guides the second axis along a predetermined path relative to the linkage carrier.

8. The latch mechanism as defined in claim 7 wherein the guide arrangement includes a linkage carrier slot in the linkage carrier to guide the second axis along the predetermined path relative to the linkage carrier.

9. The latch mechanism as defined in claim 1 including a power actuator arrangement operable to move the toggle linkage between the first toggle linkage position and the second toggle linkage position.

10. The latch mechanism as defined in claim 9 wherein one of the first link and the second link includes a link slot, and the power actuator arrangement includes a power actuator pin positioned in the link slot to move the toggle linkage between the first toggle linkage position and the second toggle linkage position.

11. The latch mechanism as defined in claim 10 wherein the power actuator pin is rotatable about a pivot mounted on the latch chassis.

12. The latch mechanism as defined in claim 1 including a second release handle operably connected to the pawl via the transmission path to selectively move the pawl from the engaged position to the disengaged position.

13. The latch mechanism as defined in claim 12 wherein the second release handle has a second handle rest position and a second handle actuated position, and with the second release handle in the actuated position, the toggle linkage in the second toggle linkage position, and the pawl in the engaged position, movement of the toggle linkage to the first toggle linkage position operably couples the second release handle to the pawl to move the pawl to the disengaged position.

14. A latch mechanism comprising:
a latch chassis;
a latch bolt having a closed position and an open position;
a pawl having an engaged position at which the pawl holds the latch bolt in the closed position and a disengaged position at which the pawl allows the latch bolt to move to the open position;
a first release handle operably connected to the pawl via a transmission path to selectively move the pawl from the engaged position to the disengaged position;
the transmission path including a toggle linkage having a first link pivotable about a first axis and a second link, the first link and the second link being pivotable relative to each other about a common axis, and the second link having a load application point remote from the common axis; and
a stop to limit rotation of the second link in a first direction relative to the first link,
wherein the toggle linkage has a first toggle linkage position wherein the common axis is positioned on a first side of a line joining the first axis and the load application point, and the stop is engaged to operably couple the first release handle with the pawl, and
wherein the toggle linkage has a second toggle linkage position wherein the common axis is positioned on a second side of the line joining the first axis and the load application point to operably decouple the first release handle from the pawl.
